(19) United States
(12) Patent Application Publication
(10) Pub. No.: US 2025/0350603 A1
(43) Pub. Date: Nov. 13, 2025

(54) Intelligent Creation of Secure Roles for Role-Based Access Control

(71) Applicant: SAP SE, Walldorf (DE)

(72) Inventors: Vipul KHULLAR, Gurugram (IN); Roland LUCIUS, Wiesbaden (DE); Isadora KIRCHMAIER, Walldorf (DE); Christian HOCHWARTH, Heidelberg (DE)

(21) Appl. No.: 18/656,727

(22) Filed: May 7, 2024

(51) Int. Cl. H04L 9/40

(52) U.S. Cl. CPC H04L 63/102; H04L 63/101

(57) ABSTRACT

Disclosed herein are system, method, and computer program product embodiments for creating a tailored access profile for improving the security of an access control system. An embodiment operates by extracting application access requirements for a role from a role description using a first large language model. The embodiment then generates an embedding corresponding to the application access requirements using a second large language model. The embodiment then searches for a first access profile in a data store based on the embedding. The embodiment then generates a second access profile based on the application access requirements using the first large language model. The embodiment then selects the first access profile or the second access profile based on the application access requirements. The embodiment finally tailors the selected access profile based on feedback, thereby creating the tailored access profile.

### BACKGROUND

Role-based access control (RBAC) systems manage and restrict access to resources in an organization based on the roles and privileges assigned to its users. In a typical RBAC system, roles that bundle access rights needed for specific tasks and responsibilities are first created. Then, users are assigned one or more roles that grant them the appropriate level of access to perform their tasks. However, as the number of applications and resources in an environment grows, security issues arise in seeking to define roles with the proper scope of access. Roles that are too permissive risk granting excess privileges that can be abused, while roles that are too restrictive may prohibit users from performing their day-to-day tasks.

Moreover, current RBAC systems rely on time-consuming processes to create and maintain roles. This can lead to the creation of poorly defined roles that do not accurately reflect the access needs of users' day-to-day responsibilities. Administrators may be pressured to take shortcuts such as hastily approving access requests without closer review or relying on predetermined role templates that might not accurately capture users' required access levels. This may also result in an inflated number of roles, many with excessive or overlapping privileges, which can increase the potential avenues for attack and make it harder to pinpoint sources of fraudulent activity.

### BRIEF DESCRIPTION OF THE DRAWINGS

The accompanying drawings are incorporated herein and form a part of the specification.

FIG. 1 is a block diagram illustrating example functionality for an access profile maintenance system (APMS), according to some embodiments.

FIG. 2 is a block diagram illustrating an example data store, according to some embodiments.

FIG. 3 is a block diagram of an example framework for interacting with an access profile maintenance system (APMS), according to some embodiments.

FIG. 4 is a flowchart illustrating example operations for creating a tailored access profile for improving the security of an access control system, according to some embodiments.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for creating a tailored access profile for improving the security of an access control system.

Role-based access control (RBAC) systems manage and restrict access to resources in an organization based on the roles and privileges assigned to its users. In a typical RBAC system, roles that bundle access rights needed for specific tasks and responsibilities are first created. Then, users are assigned one or more roles that grant them the appropriate level of access to perform their tasks. However, as the number of applications and resources in an environment grows, security issues arise in seeking to define roles with the proper scope of access. Roles that are too permissive risk granting excess privileges that can be abused, while roles that are too restrictive may prohibit users from performing their day-to-day tasks. Thus, a technical challenge lies in achieving the right balance between security and access.

Moreover, current RBAC systems rely on time-consuming processes to create and maintain roles. This can lead to the creation of poorly defined roles that do not accurately reflect the access needs of users' day-to-day responsibilities. Administrators may be pressured to take shortcuts such as hastily approving access requests without closer review or relying on predetermined role templates that might not accurately capture users' required access levels. This may also result in an inflated number of roles, many with excessive or overlapping privileges, which can increase the potential avenues for attack and make it harder to pinpoint sources of fraudulent activity.

System, apparatus, device, method and/or computer program product embodiments here solve these technological problems by improving security of the role creation and management process while enabling fine-grained granting of access rights.

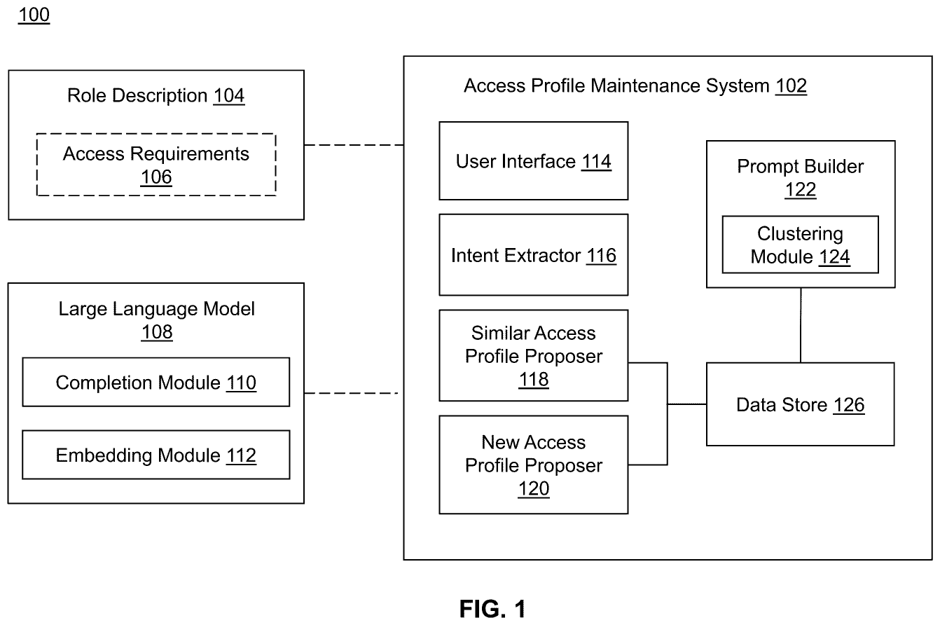

FIG. 1 is a block diagram of an example system 100 illustrating example functionality for an access profile maintenance system (APMS) 102, according to some embodiments. The example system 100 is provided for the purpose of illustration only and does not limit the disclosed embodiments. APMS 102 may improve the security of the role creation and management process by creating access profiles with fine-grained access. As used herein, an “access profile” defines tasks and responsibilities a user can perform within a system. An access profile may be associated with application access lists. As used herein, an “application access list” may enumerate the different access permissions a user may have regarding different applications within a system.

In some embodiments, APMS 102 may include a user interface 114, intent extractor 116, similar access profile proposer 118, new access profile proposer 120, prompt builder 122, and a data store 126. In some embodiments, prompt builder 122 may include a clustering module 124. In some embodiments, APMS may receive a role description 104 that may contain access requirements 106. In some embodiments, APMS 102 may be communicatively coupled to a large language model (LLM) 108 to assist the access profile creation process. Using LLM 108, APMS 102 may also increase the efficiency of the access profile creation and management process.

In some embodiments, an access management administrator may have a role description 104 for a new role to be created. Role description 104 may include the specific tasks and responsibilities associated with a role. In some embodiments, role description 104 may be in natural language. For example, role description 104 may be: “Person should be able to view employee salary.” In some embodiments, role description 104 may include access requirements 106 that enumerate specific applications or lists of applications a role should have access to. For example, access requirements 106 may include read and write access within an administrative application. In some embodiments, a user may interact with APMS 102 directly. For example, APMS 102 may include a user interface 114 where the user can enter role description 104. In some embodiments, user interface 114 may involve a chatbot, a series of popups, or a series of voice commands.

In some embodiments, example system 100 may include a LLM 108. LLM 108 may include a pre-trained transformer or artificial intelligence (AI) system that is configured or designed to perform various tasks based on provided inputs or prompts. In some embodiments, LLM 108 may be an artificial intelligence proxy that connects with closed source enterprise application program interfaces (APIs), such as but not limited to ChatGPT, Gemini, and Claude. In some embodiments, LLM 108 may be an open source model, such as but not limited to Llama 2, Mistral, Falcon, MPT, and BLOOM. In some embodiments, LLM 108 may include a completion module 110. Completion module 110 may focus on traditional completion tasks, such as generating a text response based on a prompt. In some embodiments, LLM 108 may include an embedding module 112. Embedding module 112 may focus on creating embeddings of text inputs. For example, embedding module may convert a text input to a list of floating point numbers that represent the text input as a whole.

In some embodiments, APMS 102 may receive the role description 104 and provide role description 104 to intent extractor 116 to extract the access requirements 106 of a role. Access requirements 106 may include a list of applications or files to which a user may need access, permissions associated with those applications or files, and any additional client specific customizations. In some embodiments, intent extractor 116 may utilize prompt builder 122 to build a prompt with instructions to extract the access requirements 106. In some embodiments, prompt builder 122 may include role description 104 when building a prompt to extract access requirements 106. Once the prompt is assembled, intent extractor may provide the prompt to LLM 108 to perform the extracting. In some embodiments, LLM 108 may utilize the completion module 110 to analyze the prompt and extract the access requirements 106.

Due to cost and practical considerations, prompt builder 122 may need to limit the number of tokens when building a prompt to provide to LLM 108. As used herein, a “token” is a unit of text to be understood by an LLM, such as LLM 108. In some embodiments, prompt builder 122 may include a clustering module 124 to help reduce the number of tokens of a prompt. For example, clustering module 124 may find the most relevant few-shot examples to include in the prompt. In some embodiments, clustering module 124 may use the k-means algorithm to cluster summaries of access profile examples and select one example from each cluster to include in the prompt. By performing clustering, prompt builder 122 can dynamically select the most relevant few-shot examples for role description 104. This allows prompt builder 122 to further customize its prompts and improve the access profile searching and generating processes by allowing for more fine-grained access profile creation.

In some embodiments, APMS 102 may receive extracted access requirements 106 from LLM 108. As a result, APMS 102 may utilize LLM 108 to generate an embedding of the extracted access requirements 106. In some embodiments, LLM 108 may utilize the embedding module 112 to analyze the extracted access requirements 106 and generate an embedding. Upon successful embedding generation, APMS 102 may receive the embedding of the access requirements 106.

In some embodiments, APMS 102 may search for existing access profiles that relate to role description 104 using similar access profile proposer 118. In some embodiments, similar access profile proposer 118 may perform a search of access profiles inside the data store 126 and return similar access profiles. For example, the similar access profile proposer 118 may use vector search using the embedding of access requirements 106 as the search criteria. The returned access profiles may include information such as: a profile identifier, a profile description, application access lists, application permissions, and client customizations. A single access profile may be associated with multiple application access lists, each of which may be grouped together to help a user accomplish different sets of tasks.

In some embodiments, APMS 102 may perform an additional search for existing parent access profiles using similar access profile proposer 118. As used herein, a “parent access profile” involves an access profile that passes its application access lists to one or more child access profiles. The child access profile may have different permissions depending on its access requirements.

In some embodiments, APMS 102 may generate a new access profile proposal using new access profile proposer 120. New access profile proposer 120 may utilize LLM 108 to generate the proposal. In some embodiments, new access profile proposer 120 may provide a prompt to the completion module 110 of LLM 108. The new access profile proposer may utilize prompt builder 122 to build a prompt for the LLM 108. When building the prompt, new access profile proposer 120 may include the role description 104, the searched access profiles returned by similar access profile proposer 118, and few-shot examples 210 of valid access profiles. New access profile proposer 120 may also include a role name or role identifier when building the prompt. Upon successfully generating a new access profile proposal, APMS 102 may receive the proposal from LLM 108.

In some embodiments, new access profile proposer 120 may also generate a child access profile proposal based on a searched parent access profile. New access profile proposer 120 may receive the searched parent access profile from similar access profile proposer 118 and employ LLM 108 to generate a new child access profile proposal.

In some embodiments, APMS 102 may present the search results of similar access profile proposer 118 and the generated new access profile proposal through user interface 114. In some embodiments, APMS 102 may also present a generated child access profile proposal. In some embodiments, a user would make a selection between the search results and the new proposals. In some embodiments, APMS 102 may present just the search results of similar access profile proposer 118, the generated new access profile proposal, or the generated child access profile proposal through the user interface 114. For example, APMS 102 may determine that the search results of similar access profile proposer 118 align closely with access requirements 106. As a result, APMS 102 may select to present just the search results to the user. In another example, APMS 102 may determine that the generated new access profile aligns closely with access requirements 106. As a result, APMS 102 may select to present just the generated new access profile proposal to the user. In yet another example, APMS 102 may determine that the generated child access profile aligns closely with access requirements 106. As a result, APMS 102 may select to present just the generated child access profile proposal to the user.

The user may provide additional feedback about the selection through the user interface 114. For example, the feedback may include instructions to remove certain application access lists that grant too much access to a role. In another example, the feedback may include instructions to remove certain application access lists that simply may not be required by a role. In another example, the feedback may also include instructions to change the wording of an access profile identifier or description to more closely align with access requirements 106.

In some embodiments, APMS 102 may regenerate the selected access profile using new access profile proposer 120 based on the user feedback. New access profile proposer 120 may utilize LLM 108 to regenerate the proposal. New access profile proposer 120 may utilize the prompt builder 122 to build a prompt for the LLM 108 with instructions to regenerate an access profile. When building the prompt, new access profile proposer 120 may include the selected access profile and the user feedback. New access profile proposer 120 may then provide the prompt to completion module 110 of LLM 108. Upon successfully regenerating a new access profile proposal, APMS 102 may receive the regenerated access profile from LLM 108.

In some embodiments, APMS 102 may present the regenerated access profile to the user through user interface 114. The user may choose to provide additional edits through user interface 114. APMS 102 may continue to regenerate and present the regenerated access profile until the user no longer provides edits and confirms that the regenerated access profile possesses the correct amount of access and aligns with access requirements 106. Upon receiving the confirmation, APMS 102 thereby creates the tailored access profile with fine-grained access, which improves the security of an access control system.

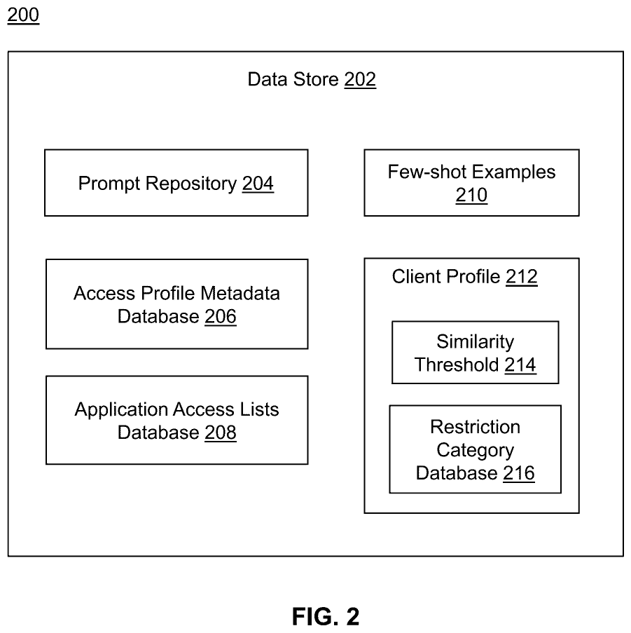

FIG. 2 is a block diagram 200 illustrating an example data store 202, according to some embodiments. Data store 202 may be an example of data store 126 (of FIG. 1) and may be utilized by various components of APMS 102 to store and retrieve data. The example data store 202 includes various data, however it is understood that in other embodiments, the data store 202 may include data in addition to or different from those described below.

In some embodiments, data store 202 may include a prompt repository 204, an access profile metadata database 206, a profile application access lists database 208, few-shot examples 210, and a client profile 212. In some embodiments, client profile 212 may include a similarity threshold 214 and restriction category database 216.

A prompt repository 204 may contain the various prompts used by the prompt builder 122 to provide to LLM 108. For example, prompt repository 204 may contain template prompts that provide the context and instructions for a desired task to be performed. In some embodiments, the template prompt may provide the context of an identity and access management environment. The template prompt may also identify naming conventions to follow, such as how to format an access profile identifier. In some embodiments, the template prompt may be stored as a chain of prompts, which indicate a sequence of steps to be provided to LLM 108. For example, the template prompt may first include instructions to extract access requirements 106 from a role description 104. The template prompt may then include instructions to generate an embedding based on the extracted access requirements 106. The template prompt may then include instructions to generate an access profile based on access requirements 106. In some embodiments, the template prompt may include instructions to generate an access profile identifier and an access profile description that correspond to the generated access profile. In some embodiments, the template prompt may also include instructions to regenerate an access profile based on proposed edits to the access profile by a user.

Data store 202 may include an access profile metadata database 206 that stores access profile information. For example, access profile metadata database 206 may store the identifier, description, application access lists, permissions, client customizations, and embedding representation associated with an access profile. When prompted, similar access profile proposer 118 may perform a search of the access profile metadata database 206 to find one or more access profiles that are similar to the search criteria. In some embodiments, the search may comprise vector search or string similarity search, such as but not limited to Levenshtein Distance, Jaro-Winkler Distance, Soundex, or Fuzzy Search. In some embodiments, the search may include performing a similarity calculation between the target embedding and embeddings of access profiles stored inside access profile metadata database 206.

In some embodiments, the calculated similarity may be compared against a similarity threshold 214. If the calculated similarity surpasses the similarity threshold 214, the corresponding access profile may be held for consideration. For example, APMS 102 may present the corresponding access profile to the user through user interface 114. If the calculated similarity does not surpass the similarity threshold 214, the corresponding access profile may be withdrawn from consideration. For example, similar access profile proposer 118 may move on to perform a similarity calculation for a different embedding stored inside access profile metadata database 206.

Data store 202 may include an application access lists database 208 that stores application access lists information. For example, application access lists database 208 may store application access lists and their corresponding embeddings. When prompted, similar access profile proposer 118 may perform a search of the application access lists database 208 to find one or more application access lists that are similar to the search criteria. In some embodiments, the search may comprise vector search or string similarity search, such as but not limited to Levenshtein Distance, Jaro-Winkler Distance, Soundex, or Fuzzy Search. In some embodiments, the search may include performing a similarity calculation between the target embedding and embeddings of application access lists stored inside application access lists database 208.

In some embodiments, the calculated similarity may be compared against a similarity threshold 214. If the calculated similarity surpasses the similarity threshold 214, the corresponding application access list may be held for consideration. For example, new access profile proposer 120 may incorporate the corresponding application access list into a prompt using prompt builder 122 to generate a new access profile proposal. If the calculated similarity does not surpass similarity threshold 214, the corresponding application access list may be held from consideration. For example, similar access profile proposer 118 may move on to perform a similarity calculation for a different embedding stored inside application access lists database 208.

Data store 202 may include a client profile 212 that stores client specific customizations. For example, client profile 212 may include a similarity threshold 214. In some embodiments, similarity threshold 214 may define the cutoff that determines which search results are held for consideration. For example, a low similarity threshold 214 may suggest a more permissive search, where many related access profiles or application access lists are held for consideration. These search results may not align closely with role description 104 and access requirements 106, but they may provide some context on the most relevant access profiles or application access lists that currently exist in data store 202. Contrastingly, a high similarity threshold 214 may suggest a more restrictive search, where access profiles or application access lists that most closely align with role description 104 and access requirements 106 are held for consideration.

In some embodiments, client profile 212 may include a restriction category database 216 that holds client specific values, such as plant names, company code names, and descriptions. For example, a restriction category could be “Plant”, and some example values under this category may be “Plant ID: 0001, Description: North America Plant” and “Plant ID: 0002, and Description: South East Asia Plant”. In some embodiments, different access profiles and application access lists may be assigned to different restriction categories and restriction category values. As a result, one restriction category value may entail one set of access permissions and another restriction category value may entail a different set of access permissions. Similarly, sharing restriction category values may entail sharing similar sets of access permissions.

When prompted, similar access profile proposer 118 may perform a search of the restriction category database 216 to find one or more restriction category values that are similar to or associated with the search criteria. In some embodiments, the search may comprise vector search or string similarity search, such as but not limited to Levenshtein Distance, Jaro-Winkler Distance, Soundex, or Fuzzy Search. In some embodiments, the search may include performing a similarity calculation between the target embedding and restriction category values inside restriction category database 216.

In some embodiments, the calculated similarity may be compared against a similarity threshold 214. If the calculated similarity surpasses the similarity threshold 214, the corresponding restriction category value may be held for consideration. For example, new access profile proposer 120 may incorporate the corresponding restriction category value into a prompt using prompt builder 122 to generate a new access profile proposal. If the calculated similarity does not surpass the similarity threshold 214, the corresponding restriction category may be held from consideration. For example, similar access profile proposer 118 may move on to perform a similarity calculation for a different restriction category stored inside restriction category database 216.

Few-shot examples 210 may augment the prompt building process. In some embodiments, few-shot examples 210 may reinforce the naming conventions introduced by the template prompts stored in prompt repository 204. For example, the template prompts may provide a framework of the naming conventions to follow, while few-shot examples 210 may provide an example of a valid access profile. In some embodiments, few-shot examples 210 may identify additional naming conventions to follow, such as client-specific naming conventions. For example, few-shot examples 210 may identify proper usage of restriction categories. When building a prompt, prompt builder 122 may provide few-shot examples 210 alongside a template prompt to LLM 108.

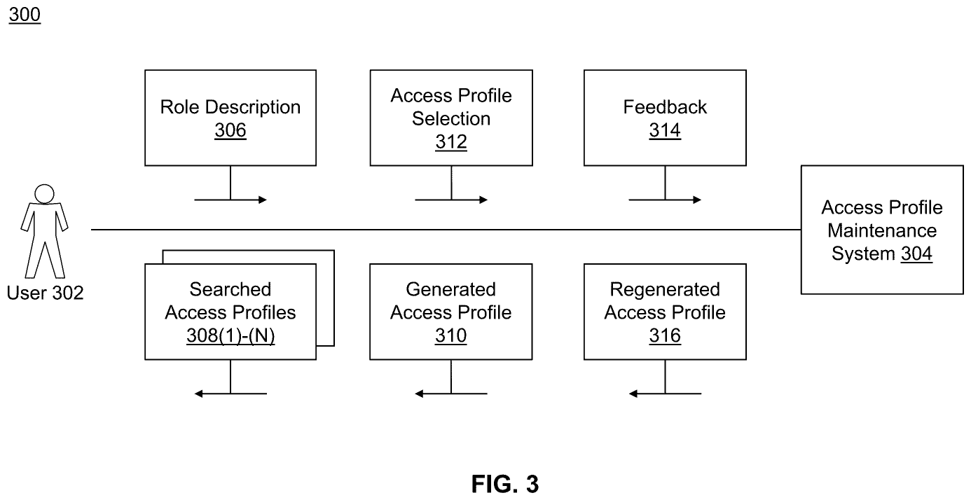

FIG. 3 illustrates a block diagram of an example framework for interacting with an access profile maintenance system (APMS) 304, according to some embodiments. As illustrated in FIG. 3, the example framework includes an APMS 304, which is associated with a user 302. To initiate the access profile creation process, user 302 provides a role description 306 to the APMS 304. Role description 306 may be in natural language and may include information about the tasks and responsibilities of a role.

Upon receiving role description 306, APMS 304 may perform one or more searches of a data store 126 to find access profiles that align with role description 306. APMS 304 may also generate a new access profile based on role description 306. In some embodiments, APMS 304 may present the searched access profiles 308(1)-(N) and the generated access profile 310 to user 302. In some embodiments, APMS 304 may present just the searched access profiles 308(1)-(N) or just the generated access profile 310 to user 302. For example, APMS 304 may determine that the searched access profiles 308(1)-(N) align closely with role description 306. As a result, APMS 304 may select to present just the search results to the user. In another example, APMS 304 may determine that the searched access profiles 308(1)-(N) do not align closely with role description 306. As a result, APMS 304 may select to present just the generated access profile 310 to user 302.

When presented with the one or more access profiles, user 302 may perform an access profile selection 312 by selecting among the searched access profiles 308(1)-(N) and generated access profile 310. The access profile selection 312 may be based on the role description 306 and any other considerations by the user 302. The access profile selection 312 may also be performed automatically, in the cases where APMS 304 only presents searched access profile 308(1) or generated access profile 310.

User 302 may wish to edit the access profile selection 312. For example, user 302 may remove certain application access lists that grant too much access to a role. In another example, user 302 may remove certain application access lists that simply may not be required by a role. In another example, user 302 may change the wording of an access profile identifier or description to more closely align access profile selection 312 with role description 306. These edits may be provided to APMS 304 as feedback 314. Upon receiving this feedback 314, APMS 304 may regenerate the access profile selection 312 based on feedback 314 and present the regenerated access profile 316 to user 302. APMS 304 may continue to regenerate and present the regenerated access profile 316 until the user no longer provides edits in feedback 314.

The user 302 may also accept the access profile selection 312 as is. For example, user 302 may simply confirm access profile selection 312 without making any edits. This confirmation may be provided to APMS 304 as feedback 314.

Upon receiving no further edits, APMS 304 may create the new access profile, and APMS 304 may persist the new access profile data inside data store 126. For example, APMS 304 may generate an embedding of the new access profile using LLM 108 and store the embedding inside data store 126. APMS 304 may also create a few-shot example based on the new access profile and store the few-shot example inside data store 126.

A key differentiation of this tailoring process is the emphasis on augmentation over automation. Rather than blindly accepting the generated output of the LLM 108, another party (e.g. user 302) always retains control and oversight. This approach ensures that the final access profiles possess the right amount of access, which leads to improved security of access control systems.

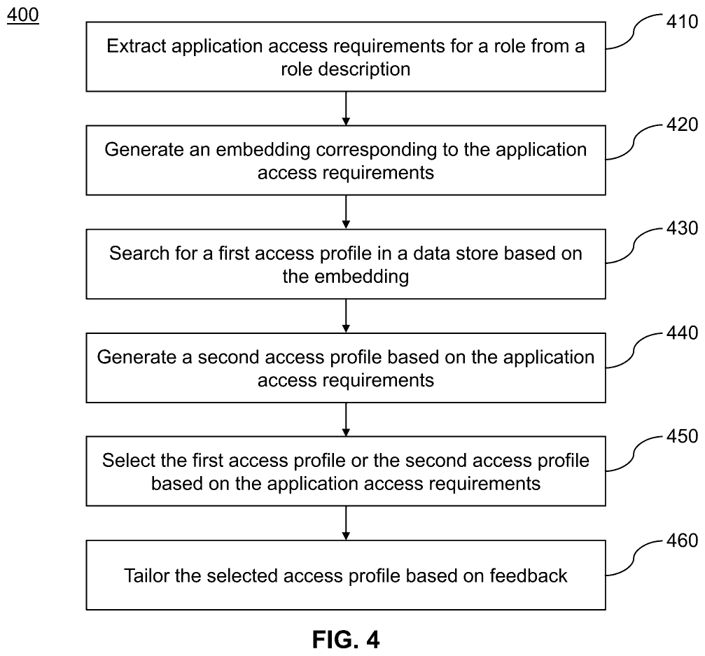

FIG. 4 is a flowchart 400 illustrating example operations for creating a tailored access profile for improving the security of an access control system, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIG. 1. However, method 400 is not limited to that example embodiment.

In 410, an access profile maintenance system may extract application access requirements for a role from a role description. For example, APMS 102 may receive role description 104 from a user and provide role description 104 to intent extractor 116. Intent extractor 116 may then provide role description 104 to prompt builder 122 to assemble a prompt to extract access requirements 106 from role description 104. Prompt builder 122 may retrieve a template prompt from data store 126 that contains instructions for extracting access requirements 106 from role description 104. Intent extractor 116 may then provide the template prompt and role description 104 to LLM 108 to extract access requirements 106.

In 420, an access profile maintenance system may generate an embedding corresponding to the application access requirements. For example, APMS 102 may receive the extracted access requirements 106 from LLM 108 and provide access requirements 106 to similar access profile proposer 118. Similar access profile proposer 118 may utilize prompt builder 122 to generate an embedding from access requirements 106. Prompt builder 122 may retrieve a second template prompt from data store 126 that contains instructions for generating an embedding based on access requirements 106. Similar access profile proposer 118 may then provide the template prompt and access requirements 106 to LLM 108 to generate an embedding corresponding to access requirements 106.

In 430, an access profile maintenance system may search for a first access profile in a data store based on the embedding. For example, APMS 102 may receive the generated embedding from LLM 108 and provide the generated embedding to similar access profile proposer 118. Similar access profile proposer may initiate a search within data store 126 to find access profiles, application access lists, or restriction categories that align with the generated embedding. Similar access profile proposer may also initiate a search for a parent access profile that aligns with the generated embedding. This search may be conducted in series or in parallel. Upon completing the search, APMS 102 may present the most relevant access profiles to the user through user interface 114.

In 440, an access profile maintenance system may generate a second access profile based on the application access requirements. For example, new access profile proposer 120 may receive the relevant access profiles, application access lists, or restriction categories resulting from the search performed by similar access profile proposer 118. New access profile proposer 120 may utilize prompt builder 122 to generate a new access profile using the relevant access profiles, application access lists, restriction categories, or access requirements 106. For example, prompt builder 122 may retrieve a third template prompt from data store 126 that contains instructions for generating a new access profile based on relevant access profiles, application access lists, restriction categories, or access requirements 106. New access profile proposer 120 may provide the template prompt and relevant access profiles, application access lists, restriction categories, or access requirements 106 to LLM 108 to generate a new access profile. Upon completing the generating, APMS 102 may present the new access profile to the user through user interface 114.

In some embodiments, new access profile proposer 120 may also generate a child access profile. For example, new access profile proposer 120 may receive a searched parent access profile from similar access profile proposer 118 along with relevant application access lists or restriction categories returned from the search. New access profile proposer may then employ LLM 108 to generate a new child access profile based on the searched parent access profile, relevant application access lists, restriction categories, or access requirements 106. This generation may be performed in series or in parallel.

In 450, an access profile maintenance system may select the first access profile or the second access profile based on the application access requirements. For example, APMS 102 may present the searched access profile and the generated access profile to the user through user interface 114. In some embodiments, an APMS 102 may also present a generated child access profile to the user. In some embodiments, APMS 102 may present just the searched access profile, the generated access profile, or the generated child access profile to the user through user interface 114. For example, APMS 102 may determine that the searched access profile aligns closely with access requirements 106. As a result, APMS 102 may select to present just the searched access profile to the user. In another example, APMS 102 may determine that the generated access profile aligns closely with access requirements 106. As a result, APMS 102 may select to present just the generated new access profile proposal to the user. In yet another example, APMS 102 may determine that the generated child access profile aligns closely with access requirements 106. As a result, APMS 102 may select to present just the generated child access profile proposal to the user.

APMS 102 may then receive a selection from the user among the searched access profile(s) and the generated access profile(s) based on access requirements 106. For example, APMS 102 may receive the searched access profile as the selection if the searched access profile more closely aligns with access requirements 106. In another example, APMS 102 may receive the generated access profile as the selection if the generated access profile more closely aligns with access requirements 106. In another example, APMS 102 may receive the generated child access profile as the selection if the generated child access profile more closely aligns with access requirements 106. In another example, APMS 102 may perform the selection automatically, in the case where APMS 102 only presents the searched access profile or the generated access profile. APMS 102 may then select to move forward with either the searched access profile or generated access profile based on the selected access profile.

In 460, an access profile maintenance system may tailor the selected access profile based on feedback. For example, in addition to the selected access profile, APMS 102 may receive feedback from the user through user interface 114. In one example, the feedback may be a simple confirmation that the selection possesses the correct amount of access and aligns with access requirements 106. In another example, the feedback may include edits to the selection by the user. For example, the feedback may include instructions to remove certain application access lists that grant too much access to a role. In another example, the feedback may include instructions to remove certain application access lists that simply may not be required by a role. In another example, the feedback may also include instructions to change the wording of an access profile identifier or description to more closely align with access requirements 106. In yet another example, the feedback may include instructions to add or remove restriction category values.

Upon receiving this feedback, APMS 102 may regenerate the selected access profile based on the feedback. New access profile proposer 120 may utilize prompt builder 122 to regenerate the selected access profile. Prompt builder 122 may retrieve a fourth template prompt that contains instructions for regenerating an access profile based on edits provided in the feedback. New access profile proposer 120 may provide the template prompt and edits to LLM 108 to regenerate the selected access profile. Upon completing the regenerating, APMS 102 may present the regenerated access profile to the user through user interface 114. APMS 102 may receive additional feedback if the regenerated access profile still does not align with access requirements 106 or possesses too much access. For example, the regenerated access profile may introduce a new application access list that grants too much access to a role. Then, the additional feedback may include instructions to remove the newly introduced application access list. APMS 102 may continue to regenerate and present a regenerated access profile 316 until the user no longer provides edits in the feedback and confirms that the regenerated access profile possesses the correct amount of access and aligns with access requirements 106. Upon receiving the confirmation, APMS 102 thereby creates the tailored access profile with fine-grained access, which improves the security of an access control system.

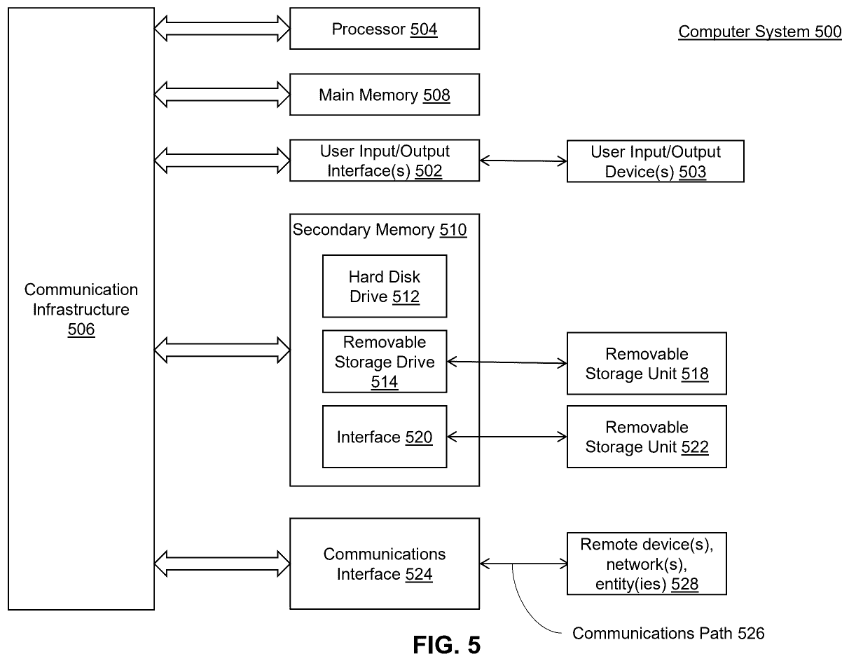

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method for creating a tailored access profile for improving security of an access control system, comprising:
extracting, by at least one computer processor, application access requirements for a role from a role description using a first large language model;
generating an embedding corresponding to the application access requirements using a second large language model;
searching for a first access profile in a data store based on the embedding;
generating a second access profile based on the application access requirements using the first large language model;
selecting the first access profile or the second access profile based on the application access requirements; and
tailoring the selected access profile based on feedback, thereby creating the tailored access profile.

2. The computer implemented method of claim 1, wherein the first large language model and the second large language module are trained using a common training data set.

3. The computer implemented method of claim 1, wherein the first large language model is trained using a first training data set and the second large language module is trained using a second training data set, and the first training data set is different from the second training data set.

4. The computer implemented method of claim 1, wherein the tailoring comprises:
receiving additional feedback, wherein the additional feedback specifies how to edit the selected access profile according to the application access requirements; and
regenerating the selected access profile based on the additional feedback.

5. The computer implemented method of claim 1, further comprising:
generating an embedding corresponding to the selected access profile using the second large language model; and
storing the embedding corresponding to the selected access profile in the data store.

6. The computer implemented method of claim 1, wherein the searching the data store comprises:
calculating a similarity value between the embedding corresponding to the application access requirements and a first embedding stored in the data store;
retrieving the first embedding stored in the data store based on the similarity value being above a similarity threshold;
determining the first access profile that corresponds to the retrieved first embedding; and
returning the first access profile as a result of the searching.

7. The computer implemented method of claim 4, further comprising:
generating a few-shot prompt based on the regenerated access profile; and
storing the few-shot prompt in the data store.

8. A system for creating a tailored access profile for improving security of an access control system, comprising:
one or more memories;
at least one processor each coupled to at least one of the memories and configured to perform operations comprising:
extracting application access requirements for a role from a role description using a first large language model;
generating an embedding corresponding to the application access requirements using a second large language model;
searching for a first access profile in a data store based on the embedding;
generating a second access profile based on the application access requirements using the first large language model;
selecting the first access profile or the second access profile based on the application access requirements; and
tailoring the selected access profile based on feedback, thereby creating the tailored access profile.

9. The system of claim 8, wherein the first large language model and the second large language module are trained using a common training data set.

10. The system of claim 8, wherein the first large language model is trained using a first training data set and the second large language module is trained using a second training data set, and the first training data set is different from the second training data set.

11. The system of claim 8, wherein the tailoring comprises:
receiving additional feedback, wherein the additional feedback specifies how to edit the selected access profile according to the application access requirements; and
regenerating the selected access profile based on the additional feedback.

12. The system of claim 8, the operations further comprising:
generating an embedding corresponding to the selected access profile using the second large language model; and
storing the embedding corresponding to the selected access profile in the data store.

13. The system of claim 8, wherein the searching the data store comprises:
calculating a similarity value between the embedding corresponding to the application access requirements and a first embedding stored in the data store;
retrieving the first embedding stored in the data store based on the similarity value being above a similarity threshold;
determining the first access profile that corresponds to the retrieved first embedding; and
returning the first access profile as a result of the searching.

14. The system of claim 11, the operations further comprising:
generating a few-shot prompt based on the regenerated access profile; and
storing the few-shot prompt in the data store.

15. A non-transitory computer-readable medium having instructions stored thereon that, when executed by at least one computing device, cause the at least one computing device to perform operations comprising:
extracting application access requirements for a role from a role description using a first large language model;
generating an embedding corresponding to the application access requirements using a second large language model;
searching for a first access profile in a data store based on the embedding;
generating a second access profile based on the application access requirements using the first large language model;
selecting the first access profile or the second access profile based on the application access requirements; and
tailoring the selected access profile based on feedback, thereby creating a tailored access profile.

16. The non-transitory computer-readable medium of claim 15, wherein the first large language model and the second large language module are trained using a common training data set.

17. The non-transitory computer-readable medium of claim 15, wherein the first large language model is trained using a first training data set and the second large language module is trained using a second training data set, and the first training data set is different from the second training data set.

18. The non-transitory computer-readable medium of claim 15, wherein the tailoring comprises:
receiving additional feedback, wherein the additional feedback specifies how to edit the selected access profile according to the application access requirements; and
regenerating the selected access profile based on the additional feedback.

19. The non-transitory computer-readable medium of claim 15, the operations further comprising:
generating an embedding corresponding to the selected access profile using the second large language model; and
storing the embedding corresponding to the selected access profile in the data store.

20. The non-transitory computer-readable medium of claim 15, wherein the searching the data store comprises:
calculating a similarity value between the embedding corresponding to the application access requirements and a first embedding stored in the data store;
retrieving the first embedding stored in the data store based on the similarity value being above a similarity threshold;
determining the first access profile that corresponds to the retrieved first embedding; and
returning the first access profile as a result of the searching.
